(19) United States
(12) Patent Application Publication
(10) Pub. No.: US 2025/0062065 A1
(43) Pub. Date: Feb. 20, 2025

(54) MAGNETIC COMPONENT

(71) Applicant: Delta Electronics, Inc., Taoyuan City (TW)

(72) Inventors: Shaopeng Han, Shanghai (CN); Yanbing Xia, Shanghai (CN); Yanggui Feng, Shanghai (CN); Shaojun Chen, Shanghai (CN)

(21) Appl. No.: 18/806,091

(22) Filed: Aug. 15, 2024

(30) Foreign Application Priority Data
Aug. 16, 2023 (CN) 202322207911.9

(51) Int. Cl. H01F 27/26; H01F 27/06; H01F 27/22

(52) U.S. Cl. CPC H01F 27/263; H01F 27/06; H01F 27/22; H01F 2027/065

(57) ABSTRACT

A magnetic component is disclosed and includes a circuit board and a magnetic core set. The circuit board includes two through holes passing through a first surface and a second surface thereof. The magnetic core set includes an upper magnetic cover and a lower magnetic cover disposed on the first surface and the second surface, respectively. The upper magnetic cover includes two magnetic columns connected to the lower magnetic cover through the two through holes. The upper magnetic cover is thermally coupled to a heat dissipation device, and a volume of the upper magnetic cover is greater than that of the lower magnetic cover. A thermal resistance defined from the upper magnetic cover to the heat dissipation device is smaller than that defined from the lower magnetic cover to the heat dissipation device. It helps to make the overall heat distribution of the magnetic component more uniform.

### CROSS-REFERENCE TO RELATED APPLICATION

This application claims priority to China Patent Application No. 202322207911.9, filed on Aug. 16, 2023. The entire contents of the above-mentioned patent application are incorporated herein by reference for all purposes.

### FIELD OF THE INVENTION

The present disclosure relates to a power converter, and more particularly to a magnetic component having an asymmetric magnetic core combination structure for making the overall heat distribution more uniform and further solving the problem that the magnetic core is difficult to fix during production and installation.

### BACKGROUND OF THE INVENTION

With the improvement of the social industrial system, the demand for electricity in various industries is growing. It is becoming more and more important for power converters to achieve higher efficiency, smaller size and lower cost. Especially in the use scenarios such as the Internet, the cloud computing, the supercomputers, 5G, and the new energy vehicles, the requirements for power density are increasingly stringent, so the development of power modules has become particularly important. Therefore, how to further improve the power density of power modules has become one of the research and development focuses of engineers.

Magnetic components are important components of power modules and generally occupy a large area and volume. The magnetic components are generally transformers, inductors or coupled inductors. In order to further increase the power density of the power module and further reduce the volume, a high-frequency design is generally adopted.

In conventional power modules, a planar transformer structure is generally applied to the magnetic components. The winding coils are stacked in the form of multi-layer circuit boards, and the magnetic cores are generally designed in a symmetrical structure. When the magnetic cores have a symmetrical structure, the magnetic flux is generally evenly distributed and the loss is evenly distributed. More importantly, the symmetrical structure is easier to assemble and produce in factory automation production.

On the other hand, the mainstream heat dissipation method of the conventional power modules is mostly asymmetric heat dissipation. The water cooling or air cooling is used to dissipate the heat on one single side of the power module, so that the heat of the power module is removed. In the asymmetric heat dissipation method, the heat dissipation condition on one side of the power module is much better than the heat dissipation condition on another opposite side. It is easy to cause the overall heat distribution of the power module to be uneven.

Therefore, there is a need of providing a magnetic component having an asymmetric magnetic core combination structure, to make the overall heat distribution more uniform, further solve the problem that the magnetic core is difficult to fix during production and installation, and obviate the drawbacks encountered by the prior arts.

### SUMMARY OF THE INVENTION

An object of the present disclosure is to provide a magnetic component having an asymmetric magnetic core combination structure, to make the overall heat distribution more uniform, and further solve the problem that the magnetic core is difficult to fix during production and installation. The magnetic core set for forming a planar transformer includes an upper magnetic cover and a lower magnetic cover disposed on an upper surface and a lower surface of a circuit board, respectively. The upper magnetic cover and the lower magnetic cover are asymmetric structures. The upper magnetic cover directly thermally coupled to a heat dissipation device has a volume greater than that of the lower magnetic cover. Since the thermal resistance from the upper magnetic cover to the heat dissipation device is less than the thermal resistance from the lower magnetic cover to the heat dissipation device, when the volume of the lower magnetic cover is less than the volume of the upper magnetic cover, the heat generation of the lower magnetic cover relative to the upper magnetic cover will be reduced, thereby achieving uniform overall heat distribution and avoiding a series of problems caused by overheating of the lower magnetic cover. Furthermore, when the upper magnetic cover and the lower magnetic cover are connected through the through holes on the circuit board, the upper magnetic cover includes at least two magnetic columns connected to the lower magnetic cover through the through holes of the circuit board, so that the connection between the upper magnetic cover and the lower magnetic cover is located adjacent to the lower magnetic cover, and an asymmetric magnetic core combination structure is achieved. On the other hand, the lower magnetic cover is connected to the magnetic columns of the upper magnetic cover through at least one protrusion, or at least one air gap is formed between at least one protrusion of the lower magnetic cover and the magnetic columns of the upper magnetic cover. In addition to achieving uniform overall heat distribution, the at least one protrusion having the protruding height of not less than 0.9 mm is more helpful for installation and fixing the upper magnetic cover and the lower magnetic cover to the circuit board. It further solves the problem of that the magnetic core is difficult to fix during production and installation.

An object of the present disclosure is to provide a magnetic component. In a magnetic core set of an upper magnetic cover and a lower magnetic cover for the planar transformer, the upper magnetic cover is directly thermally coupled to the heat dissipation device, and the connection formed by the combination of the upper magnetic cover and the lower magnetic cover can be designed adjacent to the lower magnetic cover to form an asymmetric magnetic core combination structure, thereby reducing the size of the lower magnetic cover and making the volume of the upper magnetic cover greater than the volume of the lower magnetic cover. Since the thermal resistance from the lower magnetic cover to the heat dissipation device is greater than the thermal resistance from the upper magnetic cover to the heat dissipation device, reducing the volume of the lower magnetic cover helps to reduce the heat generated from the lower magnetic cover. Thereby, a uniform overall heat distribution is achieved and a series of problems caused by overheating of the lower magnetic cover are avoided. Certainly, the air gap in the asymmetric magnetic core combination structure is not limited to be formed on a side column or a middle column.

In accordance with an aspect of the present disclosure, a magnetic component is provided and includes a circuit board and a magnetic core set. The circuit board includes a first surface and a second surface arranged opposite to each other, and at least two through holes passing through the first surface and the second surface. The magnetic core set includes an upper magnetic cover and a lower magnetic cover disposed on the first surface and the second surface of the circuit board, respectively, wherein the upper magnetic cover includes at least two magnetic columns connected to the lower magnetic cover through the at least two through holes, respectively, wherein the upper magnetic cover is directly thermally coupled to a heat dissipation device, and a volume of the upper magnetic cover is greater than a volume of the lower magnetic cover.

In accordance with another aspect of the present disclosure, a magnetic component is provided and includes a circuit board and a magnetic core set. The circuit board includes a first surface and a second surface disposed opposite to each other, and at least one through hole passing through the first surface and the second surface. The magnetic core set includes an upper magnetic cover and a lower magnetic cover disposed on the first surface and the second surface of the circuit board, respectively and connected through the at least one through hole, wherein the upper magnetic cover is directly thermally coupled to a heat dissipation device, a thermal resistance defined from the upper magnetic cover to the heat dissipation device is smaller than a thermal resistance defined from the lower magnetic cover to the heat dissipation device, and a volume of the upper magnetic cover is greater than a volume of the lower magnetic cover.

The beneficial effect of the present disclosure is that the embodiments of the present invention provide a magnetic component, which has an asymmetric magnetic core combination structure for making the overall heat distribution more uniform and further solving the problem that the magnetic core is difficult to fix during production and installation.

### BRIEF DESCRIPTION OF THE DRAWINGS

The above contents of the present disclosure will become more readily apparent to those ordinarily skilled in the art after reviewing the following detailed description and accompanying drawings, in which:

FIG. 1 is a structural exploded view illustrating a magnetic component according to a first embodiment of the present disclosure;

FIG. 2 is a cross-sectional structural view illustrating the magnetic component according to the first embodiment of the present disclosure;

FIG. 3 is a structural exploded view of a magnetic component according to a second embodiment of the present disclosure;

FIG. 4 is a cross-sectional structural view illustrating the magnetic component according to the second embodiment of the present disclosure;

FIG. 5 is a cross-sectional structural view illustrating a magnetic component according to a third embodiment of the present disclosure;

FIG. 6 is a cross-sectional structural view illustrating a magnetic component according to a fourth embodiment of the present disclosure;

FIG. 7 is a cross-sectional structural view illustrating a magnetic component according to a fifth embodiment of the present disclosure;

FIG. 8 is a cross-sectional structural view illustrating a magnetic component according to a sixth embodiment of the present disclosure;

FIG. 9 is a cross-sectional structural view illustrating a magnetic component according to a seventh embodiment of the present disclosure;

FIG. 10 is a cross-sectional structural view illustrating a magnetic component according to an eighth embodiment of the present disclosure;

FIG. 11 is a cross-sectional structural view illustrating a magnetic component according to a ninth embodiment of the present disclosure;

FIG. 12 is a cross-sectional structural view illustrating a magnetic component according to a tenth embodiment of the present disclosure;

FIG. 13 is a cross-sectional structural view illustrating a magnetic component according to the eleventh embodiment of the present disclosure;

FIG. 14 is a structural exploded view illustrating a magnetic component according to a twelfth embodiment of the present disclosure;

FIG. 15 is a cross-sectional structural view illustrating the magnetic component according to the twelfth embodiment of the present disclosure;

FIG. 16 is a structural exploded view illustrating a magnetic component according to the thirteenth embodiment of the present disclosure; and

FIG. 17 is a cross-sectional structural view illustrating a magnetic component according to the thirteenth embodiment of the present disclosure.

### DETAILED DESCRIPTION

The present disclosure will now be described more specifically with reference to the following embodiments. It is to be noted that the following descriptions of embodiments of this disclosure are presented herein for purpose of illustration and description only. It is not intended to be exhaustive or to be limited to the precise form disclosed. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals or letters in the various examples. This repetition is for the purpose of simplicity and clarity and does not in itself dictate a relationship between the various embodiments or configurations discussed. Further, spatially relative terms, such as “upper,” “lower,” “left,” “right” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. When an element is referred to as being “connected,” or “coupled,” to another element, it can be directly connected or coupled to the other element or intervening elements may be present. Although the wide numerical ranges and parameters of the present disclosure are approximations, numerical values are set forth in the specific examples as precisely as possible. In addition, although the “first,” “second,” “third,” and the like terms in the claims be used to describe the various elements can be appreciated, these elements should not be limited by these terms, and these elements are described in the respective embodiments are used to express the different reference numerals, these terms are only used to distinguish one element from another element. For example, a first element could be termed a second element, and, similarly, a second element could be termed a first element, without departing from the scope of example embodiments. Besides, “and/or” and the like may be used herein for including any or all combinations of one or more of the associated listed items.

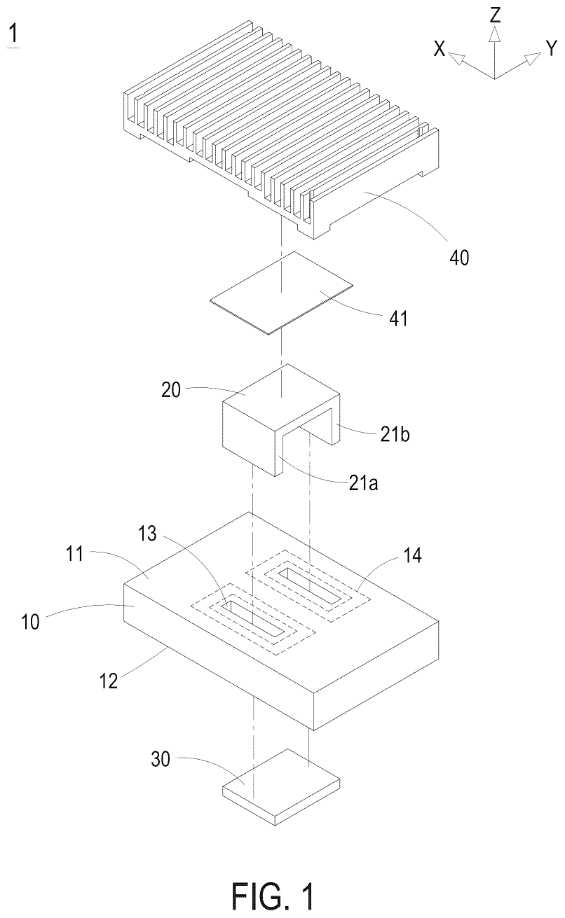

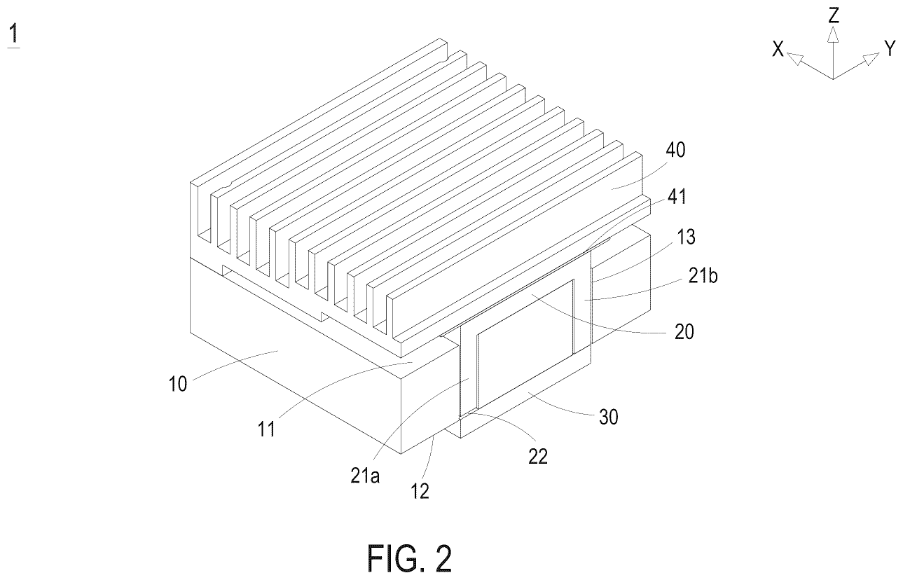

FIG. 1 and FIG. 2 schematically show a magnetic component according to a first embodiment of the present disclosure. The present disclosure provides a magnetic component 1, which is applied to a planar transformer, for example. A heat dissipation device is arranged above the magnetic component 1 to solve the heat dissipation problem when the magnetic component 1 is in operation. In the embodiment, the magnetic component 1 with the heat dissipation device above includes a circuit board 10 and a magnetic core set. The circuit board 10 includes a first surface 11 and a second surface 12 arranged opposite to each other, and at least two through holes 13 passing through the first surface 11 and the second surface 12. In the embodiment, the magnetic component 1 for example is applied to a planar transformer, and the circuit board 10 further includes a winding 14, which surrounds at least two through holes 13 and is embedded in the circuit board 10. Certainly, the present disclosure is not limited thereto. In the embodiment, the magnetic core set is an asymmetric magnetic core combination structure, and includes an upper magnetic cover 20 and a lower magnetic cover 30. The upper magnetic cover 20 is arranged on the first surface 11 of the circuit board 10, and the lower magnetic cover 30 is arranged on the second surface 12 of the circuit board 10. In the embodiment, the upper magnetic cover 20 is a U-shaped magnetic core, the lower magnetic cover 30 is an I-shaped magnetic core, and a volume of the lower magnetic cover 30 is smaller than a volume of the upper magnetic cover 20. The upper magnetic cover 20 includes two magnetic columns, such as two side columns 21a, 21b, which are connected to the lower magnetic cover 30 through two through holes 13 respectively. Furthermore, in the embodiment, the two side columns 21a, 21b can form at least one air gap 22 disposed adjacent to the lower magnetic cover 30. The top surface of the upper magnetic cover 20 parallel to the XY plane is directly thermally coupled to a heat sink, such as a heat sink 40 or a thermal pad 41, to form a heat dissipation path along the vertical direction (i.e., the Z axial direction), and the thermal resistance defined from the upper magnetic cover 20 to the heat sink is smaller than the thermal resistance defined from the lower magnetic cover 30 to the heat sink. Notably, in the embodiment, the volume of the upper magnetic cover 20 is greater than the volume of the lower magnetic cover 30. In the heat dissipation path of the magnetic core set, the thermal resistance defined from the lower magnetic cover 30 to the heat dissipation device is greater than that defined from the upper magnetic cover 20 to the heat dissipation device, but the volume of the lower magnetic cover 30 is smaller than the volume of the upper magnetic cover 20. Therefore, the heat generated from the lower magnetic cover 30 relative to the upper magnetic cover 20 can be reduced, thereby achieving uniform distribution of overall heat and avoiding a series of problems caused by overheating of the lower magnetic cover 30.

In the embodiment, the upper magnetic cover 20 is a U-shaped magnetic core, the lower magnetic cover 30 is an I-shaped magnetic core, and the upper magnetic cover 20 has at least two magnetic columns, such as two side columns 21a, 21b. Furthermore, the air gap 22 for example is disposed between the left column 21a and the top surface of the lower magnetic cover 30, and the height of the left column 21a is slightly smaller than the height of the right column 21b. In other embodiments, the air gap 22 for example is disposed between the right column 21b and the top surface of the lower magnetic cover 30. Certainly, the present disclosure is not limited thereto.

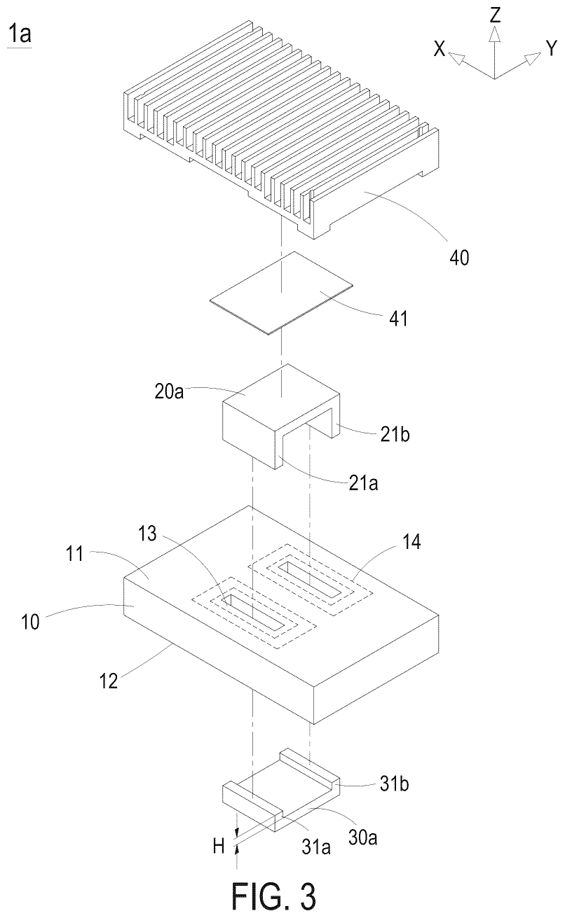

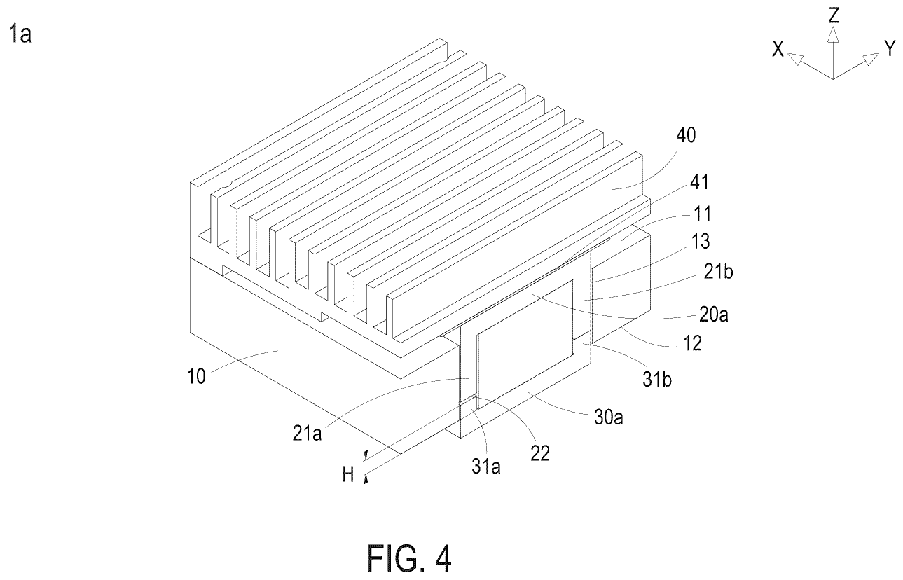

FIG. 3 and FIG. 4 schematically show a magnetic component according to a second embodiment of the present disclosure. In the embodiment, the structures, elements and functions of the magnetic component 1a are similar to those of the magnetic component 1 of FIGS. 1 to 2, and are not redundantly described herein. In the embodiment, the magnetic component 1a includes a circuit board 10 and an asymmetric magnetic core set having an upper magnetic cover 20a and a lower magnetic cover 30a. The upper magnetic cover 20a is a U-shaped magnetic core and including two side columns 21a, 21b. The lower magnetic cover 30a is a U-shaped magnetic core and includes two protrusions 31a, 31b. The two protrusions 31a, 31b of the lower magnetic cover 30a are spatially corresponding to the two side columns 21a, 21b of the upper magnetic cover 20a, and are connected to the two side columns 21a, 21b through two through holes 13, respectively. In the embodiment, a volume of the two protrusions 31a, 31b is smaller than a volume of the two side columns 21a. 21b. Certainly, in other embodiments, the lower magnetic cover 30a includes only one protrusion, such as the protrusion 31a or the protrusion 31b, to spatially correspond to the side column 21a or the side column 21b of the upper magnetic cover 20a. Furthermore, in the embodiment, the air gap 22 is disposed between the left column 21a and the left protrusion 31a of the lower magnetic cover 30a, and the height of the left protrusion 31a is slightly lower than the height of the right protrusion 31b. In other embodiments, the air gap 22 may be, for example, disposed between the right column 21b and the right protrusion 31b of the lower magnetic cover 30a. Certainly, the present disclosure is not limited thereto. Since the upper magnetic cover 20a is directly thermally coupled to a heat dissipation device such as a heat sink 40 or a thermal pad 41, a heat dissipation path is formed in the vertical direction (i.e., the Z axial direction), and a thermal resistance defined from the lower magnetic cover 30a to the heat dissipation device is greater than a thermal resistance from the upper magnetic cover 20a to the heat dissipation device. Furthermore, the volume of the lower magnetic cover 30a is set to be smaller than the volume of the upper magnetic cover 20a. It is helpful to balance the heat generation of the lower magnetic cover 30a relative to the upper magnetic cover 20a, so that a uniform overall heat distribution is achieved and a series of problems caused by overheating of the lower magnetic cover 30a are avoided. Notably, at least one of the two protrusions 31a, 31b of the lower magnetic cover 30a has a protrusion height H not less than 0.9 mm. That is, the protrusion height H is greater than or equal to 0.9 mm. Thus, when the upper magnetic cover 20a and the lower magnetic cover 30a are connected through the through hole 13 on the circuit board 10, the two side columns 21a, 21b of the upper magnetic cover 20a are connected to the protrusions 31a, 31b of the lower magnetic cover 30a through the through hole 13 of the circuit board 10, so that an air gap 22 is formed adjacent to the lower magnetic cover 30a and an asymmetric magnetic core combination structure is achieved. In addition to achieving uniform overall heat distribution, the protruding height H of at least one protrusion 31a, 31b of not less than 0.9 mm is more conducive to the installation and fixation of the upper magnetic cover 20a and the lower magnetic cover 30a to the circuit board 10. It further solves the problem that the magnetic core is difficult to fix during production and installation. Certainly, the present disclosure is not limited thereto.

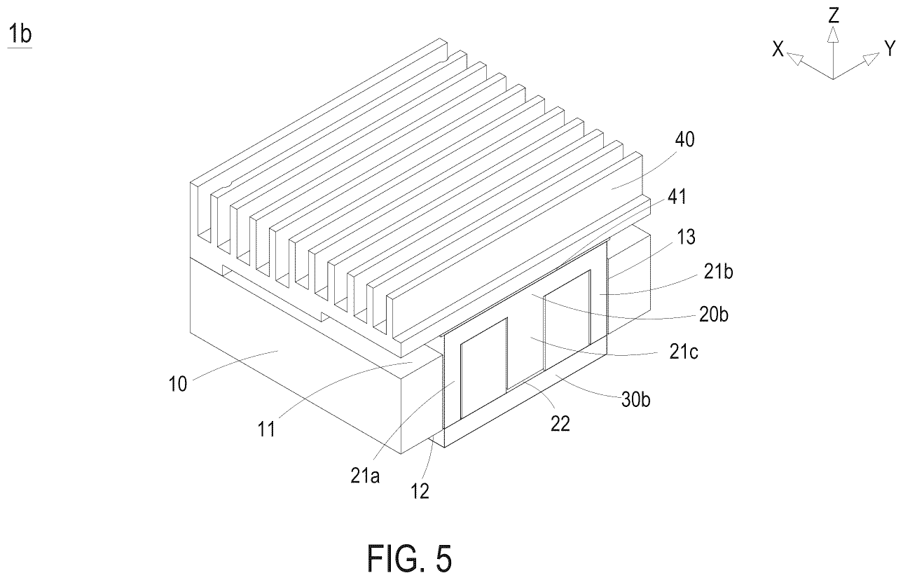

FIG. 5 schematically shows a magnetic component according to a third embodiment of the present disclosure. In the embodiment, the structures, elements and functions of the magnetic component 1b are similar to those of the magnetic component 1 of FIGS. 1 to 2, and are not redundantly described herein. In the embodiment, the magnetic component 1b includes a circuit board 10, and an asymmetric magnetic core set having an upper magnetic cover 20b and a lower magnetic cover 30b. The upper magnetic cover 20b is an E-type magnetic core, the lower magnetic cover 30b is an I-type magnetic core, and a volume of the lower magnetic cover 30b is smaller than a volume of the upper magnetic cover 20b. The upper magnetic cover 20b includes two side columns 21a, 21b and a middle column 21c, and the circuit board 10 includes three through holes 13. Furthermore, in the embodiment, an air gap 22 is disposed at a junction of the middle column 21c and the top surface of the lower magnetic cover 30b. Certainly, in other embodiments, the two side columns 21a, 21b can form at least one air gap 22 disposed adjacent to the lower magnetic cover 30b. The present disclosure is not limited thereto. Since the upper magnetic cover 20b is directly thermally coupled to a heat dissipation device such as a heat sink 40 or a thermal pad 41, a heat dissipation path is formed along the vertical direction (i.e., the Z axial direction), and a thermal resistance defined from the lower magnetic cover 30b to the heat dissipation device is greater than a thermal resistance defined from the upper magnetic cover 20b to the heat dissipation device. The volume of the lower magnetic cover 30b is further set to be smaller than the volume of the upper magnetic cover 20b. It is helpful to balance the heat generation of the lower magnetic cover 30b relative to the upper magnetic cover 20b. Thereby, a uniform overall heat distribution is achieved and a series of problems caused by overheating of the lower magnetic cover 30b are avoided.

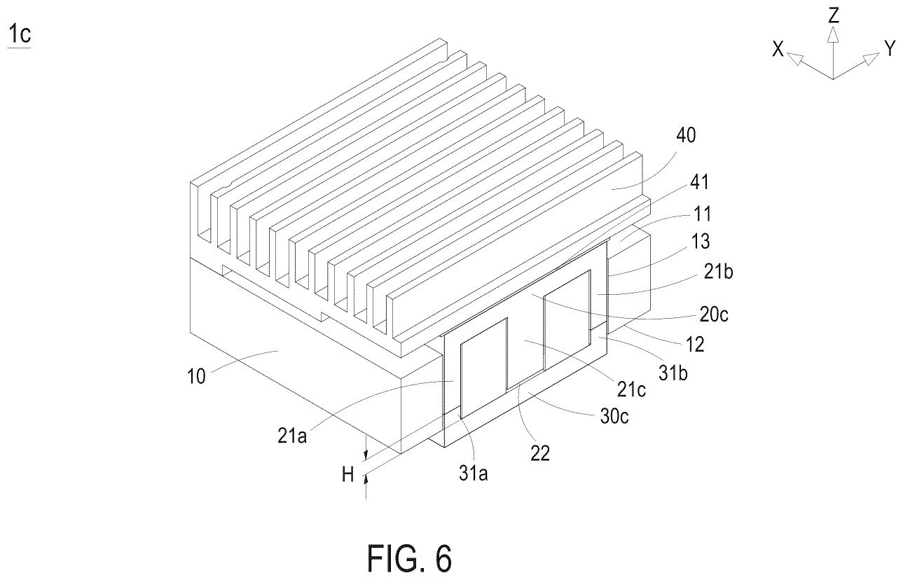

FIG. 6 schematically shows a magnetic component according to a fourth embodiment of the present disclosure. In the embodiment, the structures, elements and functions of the magnetic component 1c are similar to those of the magnetic component 1a of FIGS. 3 to 4, and are not redundantly described herein. In the embodiment, the magnetic component 1c includes a circuit board 10, and an asymmetric magnetic core set having an upper magnetic cover 20c and a lower magnetic cover 30c. The upper magnetic cover 20c is an E-type magnetic core, the lower magnetic cover 30c is a U-type magnetic core, and a volume of the lower magnetic cover 30c is smaller than a volume of the upper magnetic cover 20c. The upper magnetic cover 20c includes two side columns 21a, 21b and a middle column 21c. The lower magnetic cover 30c includes two protrusions 31a, 31b. The circuit board 10 includes three through holes 13. In the embodiment, the two protrusions 31a, 31b of the lower magnetic cover 30c are spatially corresponding to the two side columns 21a, 21b of the upper magnetic cover 20c. Moreover, the two side columns 21a, 21b and the middle column 21c of the upper magnetic cover 30c are connected to the lower magnetic cover 30c through three through holes 13, respectively. In the embodiment, the volume of the two protrusions 31a, 31b is smaller than the volume of the two side columns 21a, 21b. Moreover, in the embodiment, a height of the middle column 21c along the vertical direction (i.e., the Z axial direction) is greater than a height of the two side columns 21a, 21b. Furthermore, in the embodiment, an air gap 22 for example is formed at a junction of the middle column 21c of the upper magnetic cover 20c and the top surface of the lower magnetic cover 30c. Certainly, in other embodiments, the two side columns 21a, 21b form at least one air gap 22 disposed adjacent to the lower magnetic cover 30c. The present disclosure is not limited thereto. Since the upper magnetic cover 20c is directly thermally coupled to a heat dissipation device such as a heat sink 40 or a thermal pad 41, a heat dissipation path is formed in the vertical direction (i.e., the Z axial direction), and a thermal resistance defined from the lower magnetic cover 30c to the heat dissipation device is greater than a thermal resistance defined from the upper magnetic cover 20c to the heat dissipation device. In the embodiment, the volume of the lower magnetic cover 30c is further set to be smaller than the volume of the upper magnetic cover 20c. It is helpful to balance the heat generation of the lower magnetic cover 30c relative to the upper magnetic cover 20c. Thereby, a uniform overall heat distribution is achieved, and a series of problems caused by overheating of the lower magnetic cover 30c are avoided. In addition, at least one of the two protrusions 31a, 31b of the lower magnetic cover 30c has a protrusion height H not less than 0.9 mm. That is, the protrusion height H is greater than or equal to 0.9 mm. Therefore, when the upper magnetic cover 20c and the lower magnetic cover 30c are connected through the through hole 13 on the circuit board 10, the uniform overall heat distribution is achieved through the asymmetric design of the magnetic core set, the protruding height H of at least one protrusion 31a, 31b is not less than 0.9 mm, which is more helpful for the upper magnetic cover 20c and the lower magnetic cover 30c to be installed and fixed to the circuit board 10. Thus, it further solves the problem that the magnetic core is difficult to fix during production and installation.

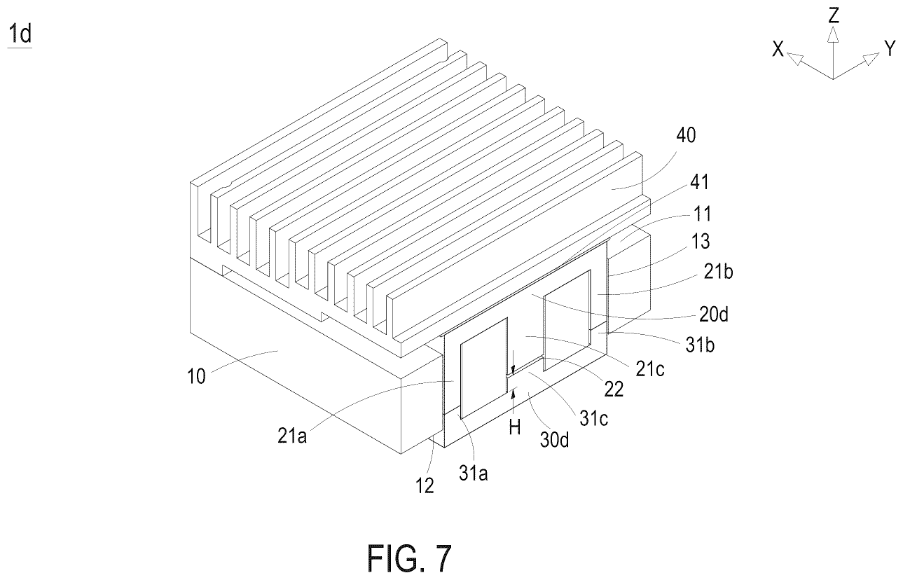

FIG. 7 schematically shows a magnetic component according to a fifth embodiment of the present disclosure. In the embodiment, the structures, elements and functions of the magnetic component 1d are similar to those of the magnetic component 1a of FIGS. 3 to 4, and are not redundantly described herein. In the embodiment, the magnetic component Id includes a circuit board 10, and an asymmetric magnetic core set having an upper magnetic cover 20d and a lower magnetic cover 30d. The upper magnetic cover 20d is an E-type magnetic core, and includes two side columns 21a, 21b and a middle column 21c. The lower magnetic cover 30d is an E-type magnetic core, and includes three protrusions 31a, 31b, 31c. In the embodiment, a volume of the lower magnetic cover 30d is smaller than a volume of the upper magnetic cover 20d. The circuit board 10 includes three through holes 13 passing through the first surface 11 and the second surface 12. In the embodiment, the three protrusions 31a, 31b, 31c of the lower magnetic cover 30d are spatially corresponding to the two side columns 21a, 21b and the middle column 21c of the upper magnetic cover 20d. The volume of the three protrusions 31a, 31b, 31c is smaller than the volume of the two side columns 21a, 21b and the middle column 21c. Furthermore, in the embodiment, an air gap 22 for example is formed at a junction of the middle column 21c of the upper magnetic cover 20d and the protrusion 31c of the lower magnetic cover 30d. Corresponding to the arrangement of the air gap 22, the height of the middle protrusion 31c is slightly lower than that of the left protrusion 31a and the right protrusion 31b. Certainly, in other embodiments, the two side columns 21a, 21b form at least one air gap 22 correspondingly disposed adjacent to the protrusions 31a, 31b of the lower magnetic cover 30d. The present disclosure is not limited thereto. Since the upper magnetic cover 20d is directly thermally coupled to a heat dissipation device such as a heat sink 40 or a thermal pad 41, a heat dissipation path is formed in the vertical direction (i.e., the Z axial direction), and a thermal resistance defined from the lower magnetic cover 30d to the heat dissipation device is greater than a thermal resistance defined from the upper magnetic cover 20d to the heat dissipation device. Furthermore, in the embodiment, the volume of the lower magnetic cover 30d is set to be smaller than the volume of the upper magnetic cover 20d. It is helpful to balance the heat generation of the lower magnetic cover 30d relative to the upper magnetic cover 20d, thereby achieving uniform overall heat distribution and avoiding a series of problems caused by overheating of the lower magnetic cover 30d. In addition, at least one of the three protrusions 31a, 31b, 31c of the lower magnetic cover 30d has a protruding height H of not less than 0.9 mm. It is more helpful for the upper magnetic cover 20d and the lower magnetic cover 30d to be installed and fixed to the circuit board 10. Thereby, the problem that the magnetic core is difficult to fix during production and installation is further solved.

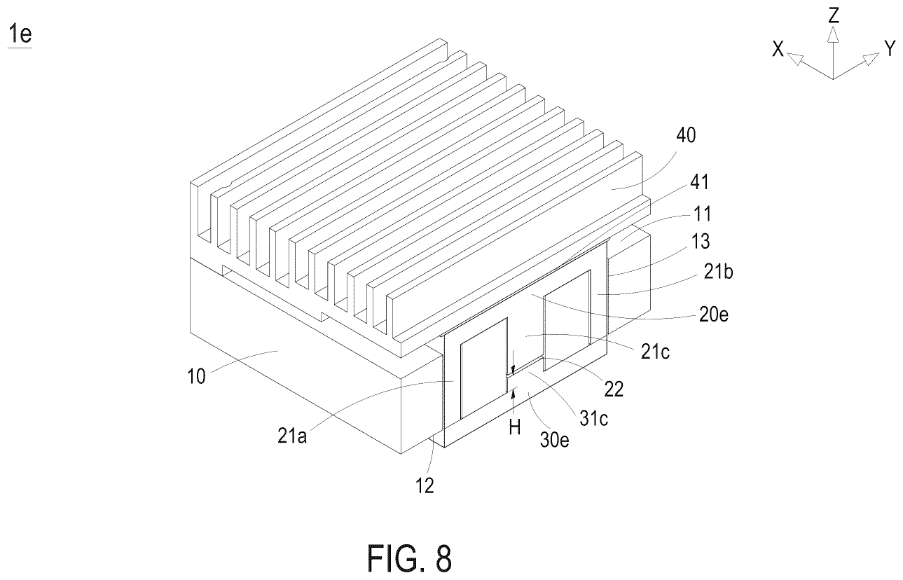

FIG. 8 schematically shows a magnetic component according to a sixth embodiment of the present disclosure. In the embodiment, the structures, elements and functions of the magnetic component 1e are similar to those of the magnetic component 1a of FIGS. 3 to 4, and are not redundantly described herein. In the embodiment, the magnetic component 1e includes a circuit board 10, and an asymmetric magnetic core set having an upper magnetic cover 20e and a lower magnetic cover 30e. The upper magnetic cover 20e is an E-shaped magnetic core, and includes two side columns 21a, 21b and a middle column 21c. The lower magnetic cover 30e includes a protrusion 31c, which is spatially corresponding to the middle column 21c of the upper magnetic cover 20e. In the embodiment, a volume of the protrusion 31c is smaller than a volume of the middle column 21c, and a volume of the lower magnetic cover 30e is smaller than a volume of the upper magnetic cover 20e. The circuit board 10 includes three through holes 13 passing through the first surface 11 and the second surface 12. Furthermore, in the embodiment, an air gap 22 is formed at a junction of the middle column 21c of the upper magnetic cover 20e and the protrusion 31c of the lower magnetic cover 30e. Certainly, in other embodiments, the two side columns 21a, 21b can form at least one air gap 22 corresponding to the adjacent lower magnetic cover 30e, and the present disclosure is not limited thereto. Since the upper magnetic cover 20e is directly thermally coupled to a heat dissipation device such as a heat sink 40 or a thermal pad 41, a heat dissipation path is formed along the vertical direction (i.e., the Z axial direction), and a thermal resistance defined from the lower magnetic cover 30e to the heat dissipation device is greater than a thermal resistance defined from the upper magnetic cover 20e to the heat dissipation device. In the embodiment, the volume of the lower magnetic cover 30e is further set to be smaller than the volume of the upper magnetic cover 20e. It is helpful to balance the heat generation of the lower magnetic cover 30e relative to the upper magnetic cover 20e, thereby achieving uniform overall heat distribution and avoiding a series of problems caused by overheating of the lower magnetic cover 30e. In addition, the protrusion 31c of the lower magnetic cover 30e has a protrusion height H of not less than 0.9 mm. It is more conductive to the installation and fixation of the upper magnetic cover 20e and the lower magnetic cover 30e on the circuit board 10. Thus, the problem that the magnetic core is difficult to fix during production and installation is further solved. In other embodiments, the arrangement of the at least one protrusion 31c on the lower magnetic cover 30e is adjusted according to the position of the air gap 22. For example, a left protrusion 31a or a right protrusion 31b (Referring to FIG. 7) is disposed and spatially corresponding to the left column 21a or the right column 21b of the upper magnetic cover 20e, and the present disclosure is not limited thereto.

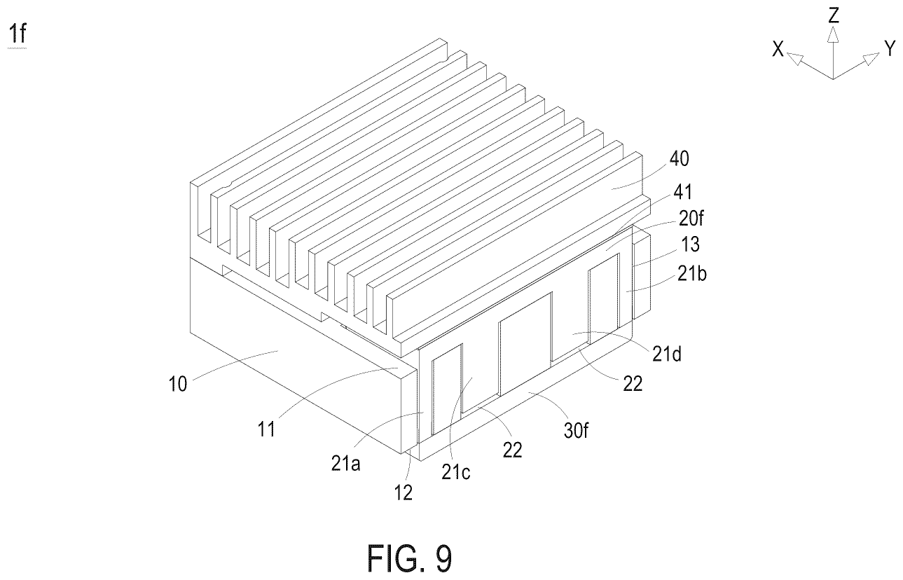

FIG. 9 schematically shows a magnetic component according to a seventh embodiment of the present disclosure. In the embodiment, the structures, elements and functions of the magnetic component if are similar to those of the magnetic component 1a of FIGS. 1 to 2, and are not redundantly described herein. In the embodiment, the magnetic component if includes a circuit board 10, and an asymmetric magnetic core set having an upper magnetic cover 20f and a lower magnetic cover 30f. The upper magnetic cover 20f includes two side columns 21a, 21b and at least two middle columns 21c, 21d. The lower magnetic cover 30 is an I-shaped magnetic core. A volume of the lower magnetic cover 30f is smaller than a volume of the upper magnetic cover 20f. The circuit board 10 includes at least four through holes 13. The two side columns 21a, 21b and at least two middle columns 21c, 21d are connected to the lower magnetic cover 30f through at least four through holes 13, respectively. Furthermore, in the embodiment, at least one air gap 22 is formed at a junction of the middle columns 21c, 21d and the top surface of the lower magnetic cover 30f. Certainly, in other embodiments, the two side columns 21a, 21b can form at least one air gap 22 disposed adjacent to the lower magnetic cover 30f, and the present invention is not limited thereto. Since the upper magnetic cover 20f is directly thermally coupled to a heat dissipation device such as a heat sink 40 or a thermal pad 41, a heat dissipation path is formed along the vertical direction (i.e., the Z axial direction), and a thermal resistance defined from the lower magnetic cover 30f to the heat dissipation device is greater than a thermal resistance defined from the upper magnetic cover 20f to the heat dissipation device. In the embodiment, the volume of the lower magnetic cover 30f is further set to be smaller than the volume of the upper magnetic cover 20f. It helps to balance the heat generation of the lower magnetic cover 30f relative to the upper magnetic cover 20f, thereby achieving uniform overall heat distribution and avoiding a series of problems caused by overheating of the lower magnetic cover 30f. Certainly, the present disclosure is not limited thereto.

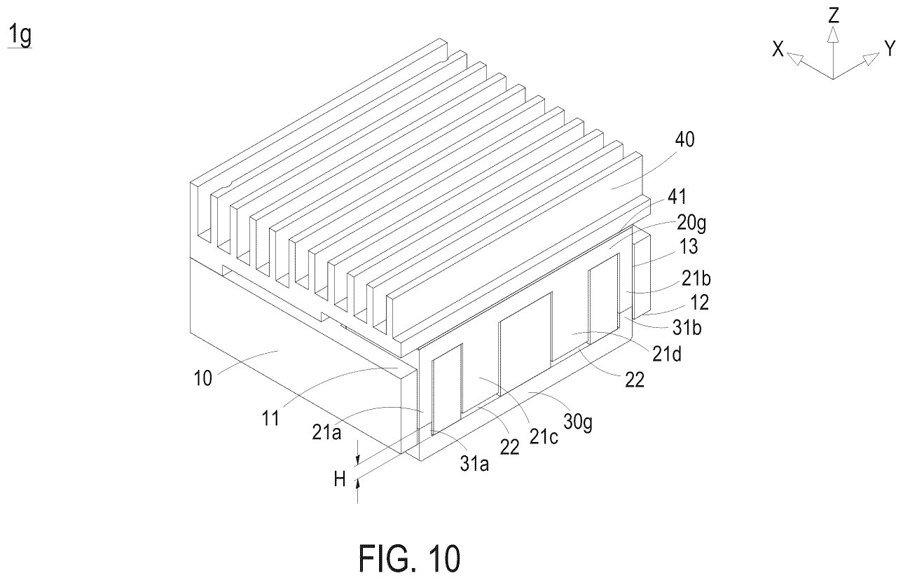

FIG. 10 schematically shows a magnetic component according to an eighth embodiment of the present disclosure. In the embodiment, the structures, elements and functions of the magnetic component 1g are similar to those of the magnetic component 1a of FIGS. 3 to 4, and are not redundantly described herein. In the embodiment, the magnetic component 1g includes a circuit board 10, and an asymmetric magnetic core set having an upper magnetic cover 20g and a lower magnetic cover 30g. The upper magnetic cover 20g includes two side columns 21a, 21b and at least two middle columns 21c, 21d. The lower magnetic cover 30g is a U-shaped magnetic core and includes two protrusions 31a, 31b. A volume of the lower magnetic cover 30g is smaller than a volume of the upper magnetic cover 20g. The circuit board 10 includes at least three through holes 13. In the embodiment, the two protrusions 31a, 31b of the lower magnetic cover 30g are spatially corresponding to the two side columns 21a, 21b of the upper magnetic cover 20g. Moreover, the two side columns 21a, 21b and at least two middle columns 21c, 21d of the upper magnetic cover 30g are connected to the lower magnetic cover 30g through at least four through holes 13, respectively. The volume of the two protrusions 31a, 31b is smaller than the volume of the two side columns 21a, 21b. Moreover, in this embodiment, a height of the middle columns 21c, 21d along the vertical direction (i.e., the Z axial direction) is greater than a height of the two side columns 21a, 21b. Furthermore, in the embodiment, at least one air gap 22 is formed at a junction of at least one middle column 21c, 21d of the upper magnetic cover 20g and the top surface of the lower magnetic cover 30g. Certainly, in other embodiments, the two side columns 21a, 21b can form at least one air gap 22 disposed adjacent to the lower magnetic cover 30g, and the present disclosure is not limited thereto. Since the upper magnetic cover 20g is directly thermally coupled to a heat dissipation device such as a heat sink 40 or a thermal pad 41, a heat dissipation path is formed along the vertical direction (i.e., the Z axial direction), and a thermal resistance defined from the lower magnetic cover 30g to the heat dissipation device is greater than a thermal resistance defined from the upper magnetic cover 20g to the heat dissipation device. Notably, in the embodiment, the volume of the lower magnetic cover 30g is further set to be smaller than the volume of the upper magnetic cover 20g. It is helpful to balance the heat generation of the lower magnetic cover 30g relative to the upper magnetic cover 20g, thereby achieving uniform overall heat distribution and avoiding a series of problems caused by overheating of the lower magnetic cover 30g. In addition, at least one of the two protrusions 31a, 31b of the lower magnetic cover 30g has a protruding height H not less than 0.9 mm. That is, the protruding height H is greater than or equal to 0.9 mm. When the upper magnetic cover 20g and the lower magnetic cover 30g are connected through the through hole 13 on the circuit board 10, in addition to achieving uniform overall heat distribution through the asymmetric magnetic core set design, the protruding height H of at least one protrusion 31a, 31b is not less than 0.9 mm, which is more helpful for the upper magnetic cover 20g and the lower magnetic cover 30g to be installed and fixed to the circuit board 10. Thereby, the problem that the magnetic core is difficult to fix during production and installation is further solved.

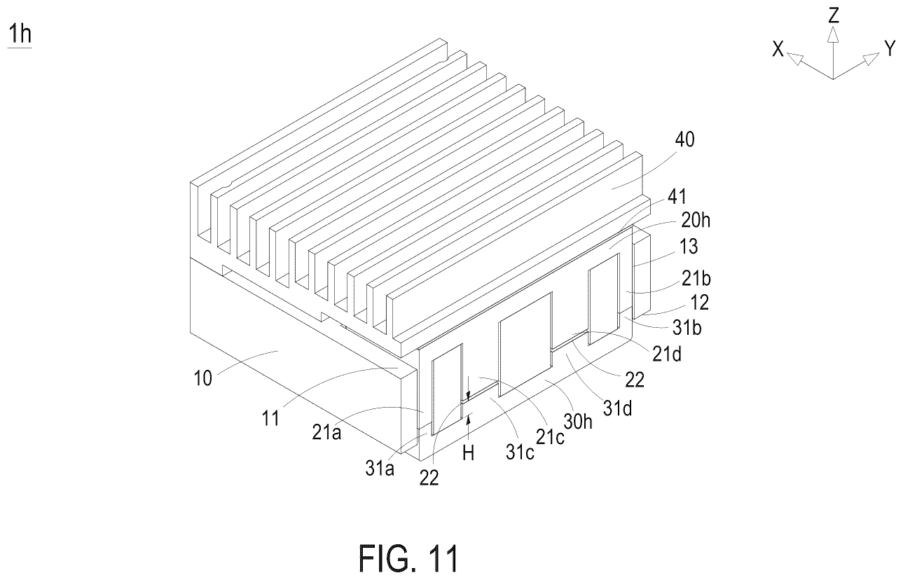

FIG. 11 schematically shows a magnetic component according to a ninth embodiment of the present disclosure. In the embodiment, the structures, elements and functions of the magnetic component 1h are similar to those of the magnetic component 1a of FIGS. 3 to 4, and are not redundantly described herein. In the embodiment, the magnetic component 1h includes a circuit board 10, and an asymmetric magnetic core set having an upper magnetic cover 20h and a lower magnetic cover 30h. The upper magnetic cover 20h includes two side columns 21a, 21b and at least two middle columns 21c, 21d. The lower magnetic cover 30h includes at least four protrusions 31a, 31b, 31c, 31d. In the embodiment, a volume of the lower magnetic cover 30h is smaller than a volume of the upper magnetic cover 20h. The circuit board 10 includes at least four through holes 13 passing through the first surface 11 and the second surface 12. In the embodiment, the four protrusions 31a, 31b, 31c, 31d of the lower magnetic cover 30h are spatially corresponding to the two side columns 21a, 21b and the two middle columns 21c, 21d of the upper magnetic cover 20h, respectively. The volume of at least the four protrusions 31a, 31b, 31c, 31d is smaller than the volume of the two side columns 21a, 21b and the two middle columns 21c, 21d. Furthermore, in the embodiment, two air gaps 22 are for example formed at a junction of the middle columns 21c, 21d of the upper magnetic cover 20h and the protrusions 31c, 31d of the lower magnetic cover 30d. Corresponding to the arrangement of the air gap 22, the height of the middle protrusions 31c, 31d is slightly lower than the height of the left protrusion 31a and the right protrusion 31b. Certainly, in other embodiments, the two side columns 21a, 21b can form at least one air gap 22 disposed adjacent to the lower magnetic cover 30h, and the present disclosure is not limited thereto. Since the upper magnetic cover 20h is directly thermally coupled to a heat dissipation device such as a heat sink 40 or a thermal pad 41, a heat dissipation path is formed in the vertical direction (i.e., the Z axial direction), and a thermal resistance defined from the lower magnetic cover 30h to the heat dissipation device is greater than a thermal resistance defined from the upper magnetic cover 20h to the heat dissipation device. In addition, the volume of the lower magnetic cover 30h is further set to be smaller than the volume of the upper magnetic cover 20h. It helps to balance the heat generation of the lower magnetic cover 30h relative to the upper magnetic cover 20h, thereby achieving uniform overall heat distribution and avoiding a series of problems caused by overheating of the lower magnetic cover 30h. In addition, at least one of the four protrusions 31a, 31b, 31c, and 31d of the lower magnetic cover 30h has a protruding height H of not less than 0.9 mm. It is more helpful for the upper magnetic cover 20h and the lower magnetic cover 30h to be installed and fixed to the circuit board 10. Thereby, the problem that the magnetic core is difficult to fix during production and installation is further solved.

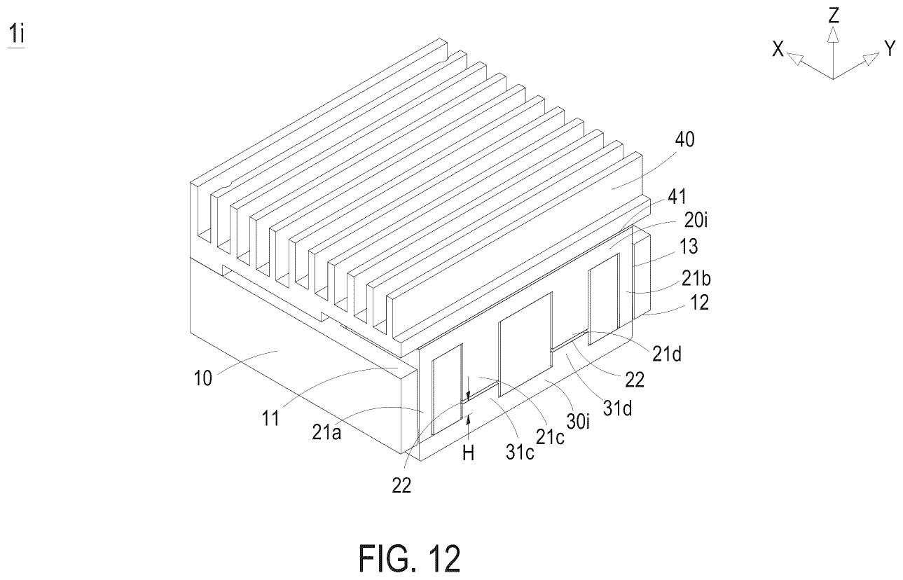

FIG. 12 schematically shows a magnetic component according to a tenth embodiment of the present disclosure. In the embodiment, the structures, elements and functions of the magnetic component 1i are similar to those of the magnetic component 1a of FIGS. 3 to 4, and are not redundantly described herein. In the embodiment, the magnetic component 1i includes a circuit board 10, and an asymmetric magnetic core set having an upper magnetic cover 20i and a lower magnetic cover 30i. The upper magnetic cover 20i includes two side columns 21a, 21b and at least two middle columns 21c, 21d. The lower magnetic cover 30i includes at least two protrusions 31c, 31d, and a volume of the lower magnetic cover 30i is smaller than a volume of the upper magnetic cover 20i. The at least two protrusions 31c, 31d of the lower magnetic cover 30i are spatially corresponding to the at least two middle columns 21c, 21d of the upper magnetic cover 20i. The circuit board 10 includes at least four through holes 13 passing through the first surface 11 and the second surface 12. In the embodiment, the two side columns 21a, 21b and at least two middle columns 21c of the upper magnetic cover 20i are connected to the lower magnetic cover 30i through at least four through holes 13, respectively. The volume of at least two protrusions 31c, 31d is smaller than the volume of the two middle columns 21c, 21d. In other embodiments, the lower magnetic cover 30i includes only one protrusion, such as protrusion 31c or protrusion 31d, and the present disclosure is not limited thereto. In the embodiment, two air gaps 22 are formed at a junction of the middle columns 21c, 21d of the upper magnetic cover 20i and the two protrusions 31c, 31d of the lower magnetic cover 30i. Certainly, in other embodiments, the two side columns 21a, 21b can form at least one air gap 22 disposed adjacent to the lower magnetic cover 30h, and the present disclosure is not limited thereto. Since the upper magnetic cover 20i is directly thermally coupled to a heat dissipation device such as a heat sink 40 or a thermal pad 41, a heat dissipation path is formed in the vertical direction (i.e., the Z axial direction), and a thermal resistance defined from the lower magnetic cover 30i to the heat dissipation device is greater than a thermal resistance defined from the upper magnetic cover 20i to the heat dissipation device. The volume of the lower magnetic cover 30i is further set to be smaller than the volume of the upper magnetic cover 20i. It is helpful to balance the heat generation of the lower magnetic cover 30i relative to the upper magnetic cover 20i, thereby achieving uniform overall heat distribution and avoiding a series of problems caused by overheating of the lower magnetic cover 30i. In addition, at least one of the two protrusions 31c, 31d of the lower magnetic cover 30i has a protruding height H of not less than 0.9 mm. It is more helpful for the upper magnetic cover 20i and the lower magnetic cover 30i to be installed and fixed on the circuit board 10. Thereby, the problem that the magnetic core is difficult to fix during production and installation is further solved. In other embodiments, the arrangement of the two protrusions 31c, 31d of the lower magnetic cover 30i is adjustable depending on the position of the air gap 22. Or one of the two protrusions 31c, 31d is omitted depending on the position of the air gap 22. The present disclosure is not limited thereto.

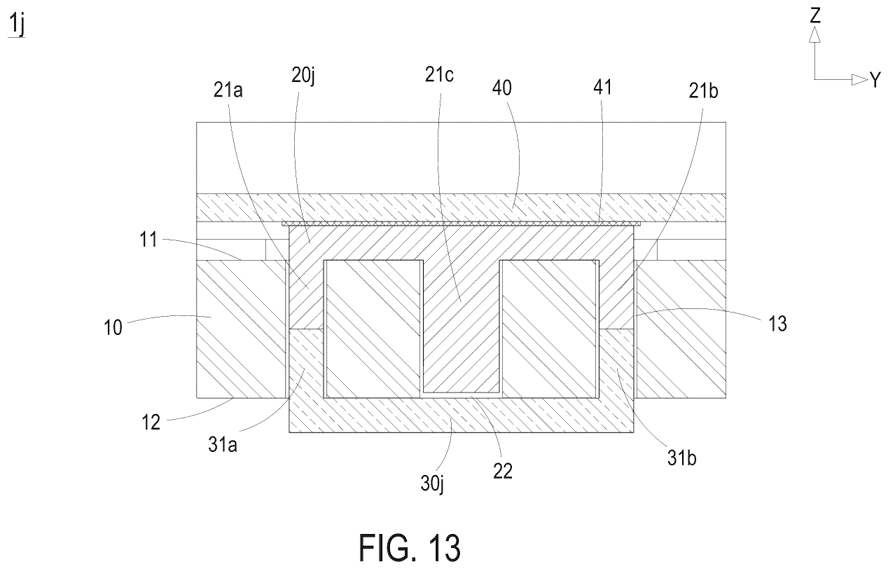

FIG. 13 schematically shows a magnetic component according to an eleventh embodiment of the present disclosure. In the embodiment, the structures, elements and functions of the magnetic component 1j are similar to those of the magnetic component 1 of FIGS. 1 to 2, and are not redundantly described herein. In the embodiment, the magnetic component 1j includes a circuit board 10, and an asymmetric magnetic core set having an upper magnetic cover 20j and a lower magnetic cover 30j, so as to be applied to the structure of a planar transformer, for example. In the embodiment, when the upper magnetic cover 20j of the magnetic core set is directly thermally coupled to a heat dissipation device such as a heat sink 40 or a thermal pad 41, the air gap 22 formed by the combination of the upper magnetic cover 20j and the lower magnetic cover 30j can be designed to adjacent to the lower magnetic cover 30j to form an asymmetric magnetic core combination structure, as shown in FIG. 13. A volume of the upper magnetic cover 20j is greater than a volume of the lower magnetic cover 30j by reducing the size of the lower magnetic cover 30j relative to the upper magnetic cover 20j. In the embodiment, the upper magnetic cover 20j is an E-shaped magnetic core, and includes two side columns 21a, 21b and a middle column 21c. The lower magnetic cover 30j is a U-shaped magnetic core and includes two side protrusions 31a, 31b. A height of the two side columns 21a, 21b of the upper magnetic cover 20j and the two side protrusions 31a, 31b of the lower magnetic cover 30j in the vertical direction (i.e., the Z axial direction) are equal or approximately equal, or the difference in height between the two is less than a preset value. In the embodiment, the asymmetric magnetic core combination structure is achieved by extending the middle column 21c of the upper magnetic cover 20j to be adjacent to the lower magnetic cover 30j and forming an air gap 22 adjacent to the top surface of the lower magnetic cover 30j at the adjacent position, so that the volume of the upper magnetic cover 20j is greater than the volume of the lower magnetic cover 30j. Certainly, in another embodiment, the volume of the upper magnetic cover 20j is greater than the volume of the lower magnetic cover 30j by extending the side columns 21a or the side columns 21b adjacent to the top surface of the lower magnetic cover 30j. In applications where the top surface of the upper magnetic cover 20j is directly thermally coupled to a heat sink or a thermal pad or other heat dissipation device, since the thermal resistance from the lower magnetic cover 30j to the heat dissipation device is greater than the thermal resistance from the upper magnetic cover 20j to the heat dissipation device, reducing the volume of the lower magnetic cover 30j relative to the upper magnetic cover 20j helps reduce the heat generation of the lower magnetic cover 30j relative to the upper magnetic cover 20j. Thereby, it allows to make the overall heat distribution more uniform and a series of problems caused by overheating of the lower magnetic cover 30j are avoided. Certainly, the air gap 22 in the asymmetric magnetic core combination structure is not limited to forming on the side columns 21a, 21b or the middle columns 21c. On the other hand, the lower magnetic cover 30j maintains at least one of the protrusions 31a, 31b with a protruding height H of not less than 0.9 mm. It helps to solve the problem that the magnetic core is difficult to fix during production and installation. Certainly, the present disclosure is not limited thereto and not redundantly described herein.

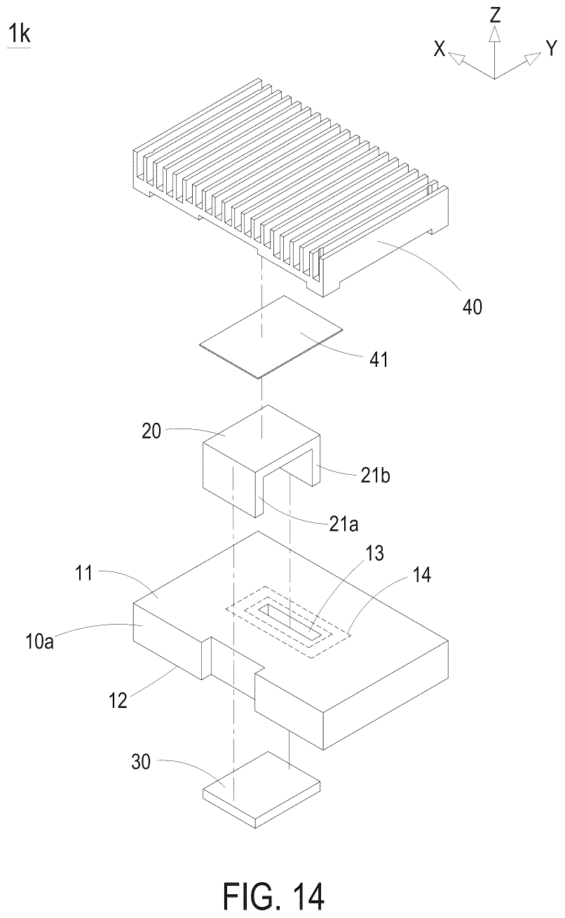

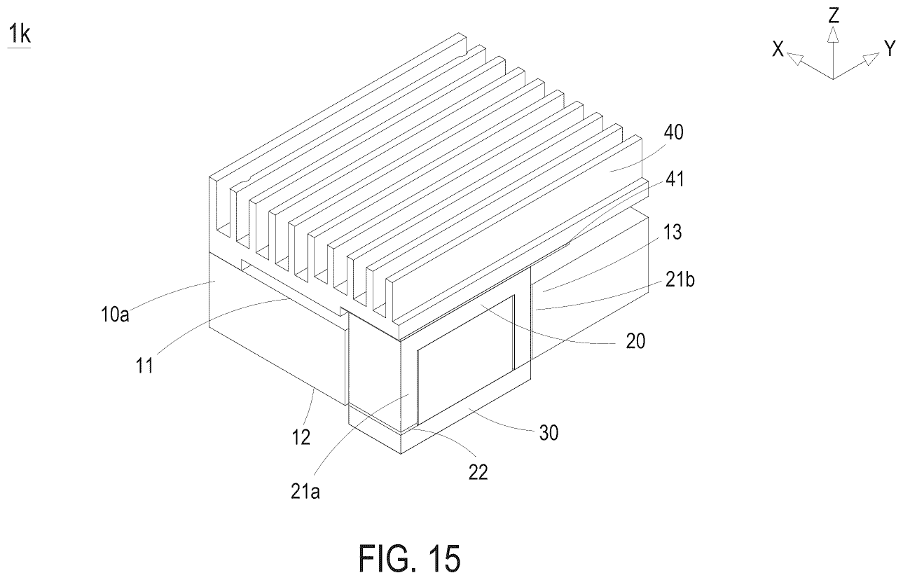

FIG. 14 and FIG. 15 schematically show a magnetic component according to a twelfth embodiment of the present disclosure. In the embodiment, the structures, elements and functions of the magnetic component 1k are similar to those of the magnetic component 1 of FIGS. 1 to 2, and are not redundantly described herein. In the embodiment, the magnetic component 1k includes a circuit board 10a, and an asymmetric magnetic core set having an upper magnetic cover 20 and a lower magnetic cover 30. The circuit board 10a includes a first surface 11 and a second surface 12 arranged opposite to each other, and a through hole 13 passing through the first surface 11 and the second surface 12. The circuit board 10a further includes a winding 14, which surrounds the through hole 13 and is embedded in the circuit board 10a. In the embodiment, the upper magnetic cover 20 is a U-shaped magnetic core, and the lower magnetic cover 30 is an I-shaped magnetic core. A volume of the lower magnetic cover 30 is smaller than a volume of the upper magnetic cover 20, and the upper magnetic cover 20 includes two magnetic columns, such as, two side columns 21a, 21b. The side column 21a is connected to the lower magnetic cover 30 along an outer edge of the circuit board 10a. A groove or a lateral through hole may be provided on the outer edge of the circuit board 10a to accommodate the side column 21a, but the present disclosure is not limited thereto. The side column 21b is connected to the lower magnetic cover 30 through the through hole 13. Furthermore, the two side columns 21a, 21b are configured to form at least one air gap 22 disposed adjacent to the lower magnetic cover 30. In the embodiment, the air gap 22 is formed between the left column 21a and the top surface of the lower magnetic cover 30. A height of the left column 21a is slightly smaller than a height of the right column 21b. In other embodiments, the air gap 22 is formed between the right column 21b and the top surface of the lower magnetic cover 30. The volume of the upper magnetic cover 20 is greater than the volume of the lower magnetic cover 30. In the heat dissipation path of the magnetic core set, although the thermal resistance defined from the lower magnetic cover 30 to the heat dissipation device is greater than that defined from the upper magnetic cover 20 to the heat dissipation device, the volume of the lower magnetic cover 30 can be further set to be smaller than that of the upper magnetic cover 20. In that, the heat generated by the lower magnetic cover 30 relative to the upper magnetic cover 20 can be reduced. Thereby, a uniform overall heat distribution is achieved and a series of problems caused by overheating of the lower magnetic cover 30 are avoided. Certainly, the present disclosure is not limited thereto.

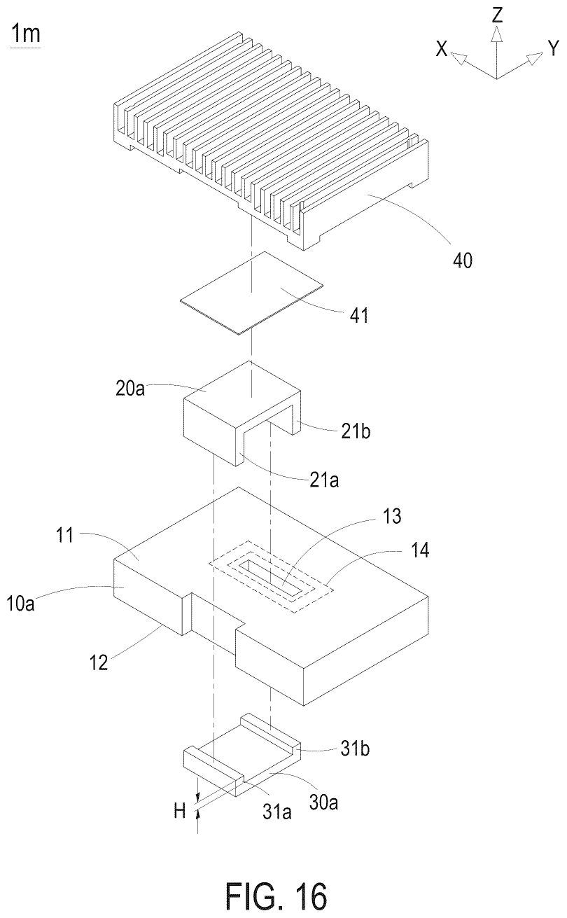

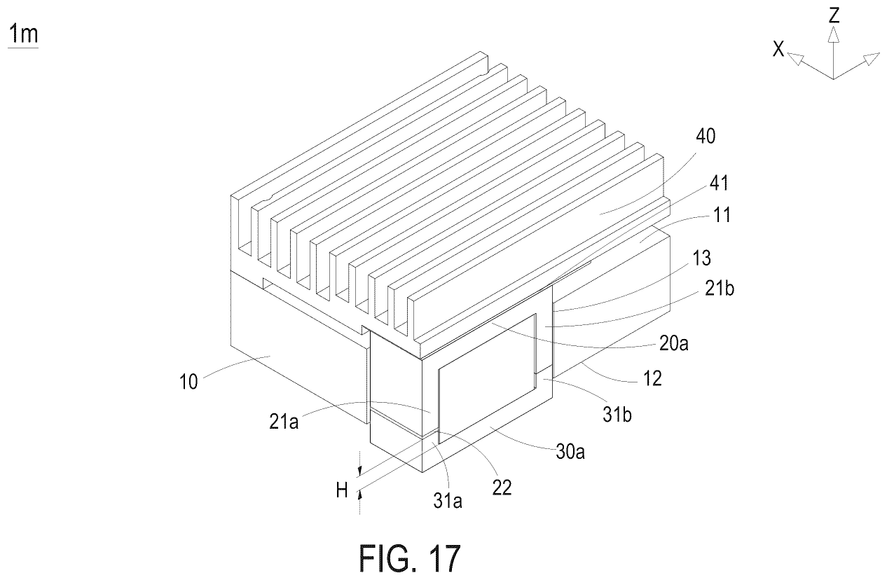

FIG. 16 and FIG. 17 schematically show a magnetic component according to a thirteenth embodiment of the present disclosure. In the embodiment, the structures, elements and functions of the magnetic component 1m are similar to those of the magnetic component 1 of FIGS. 1 to 2, and are not redundantly described herein. In the embodiment, the magnetic component 1m includes a circuit board 10a, and an asymmetric magnetic core set having an upper magnetic cover 20a and a lower magnetic cover 30a. The circuit board 10a includes a first surface 11 and a second surface 12 arranged opposite to each other, and a through hole 13 passing through the first surface 11 and the second surface 12. The circuit board 10a further includes a winding 14 surrounding the through hole 13 and embedded in the circuit board 10a. The upper magnetic cover 20a is a U-shaped magnetic core and includes two side columns 21a, 21b. The lower magnetic cover 30a is a U-shaped magnetic core and includes two protrusions 31a, 31b. A volume of the lower magnetic cover 30 is smaller than a volume of the upper magnetic cover 20. The two protrusions 31a, 31b of the lower magnetic cover 30a are spatially corresponding to the two side columns 21a, 21b of the upper magnetic cover 20a. The volume of the two protrusions 31a, 31b is smaller than the volume of the two side columns 21a, 21b. The side column 21a is connected to the lower magnetic cover 30a along an outer edge of the circuit board 10a. A groove or a lateral through hole is formed on the outer edge of the circuit board 10a to accommodate the side column 21a, but the present disclosure is not limited thereto. The side column 21b is connected to the lower magnetic cover 30a through the through hole 13. Furthermore, in the embodiment, an air gap 22 is formed between the left column 21a and the left protrusion 31a of the lower magnetic cover 30a. In the embodiment, a height of the left protrusion 31a is slightly lower than the height of the right protrusion 31b. In other embodiments, the air gap 22 is formed between the right column 21b and the right protrusion 31b of the lower magnetic cover 30a. It allows to set the volume of the upper magnetic cover 20a to be greater than the volume of the lower magnetic cover 30a. In the heat dissipation path of the magnetic core set, although the thermal resistance defined from the lower magnetic cover 30a to the heat dissipation device is greater than that defined from the upper magnetic cover 20a to the heat dissipation device, the heat generation of the lower magnetic cover 30a relative to the upper magnetic cover 20a can be reduced by setting the volume of the lower magnetic cover 30a to be smaller than the volume of the upper magnetic cover 20a. Thereby, a uniform overall heat distribution is achieved and a series of problems caused by overheating of the lower magnetic cover 30a are avoided. Certainly, the present disclosure is not limited thereto and not redundantly described herein.

In summary, the present disclosure provides a magnetic component having an asymmetric magnetic core combination structure, to make the overall heat distribution more uniform, and further solve the problem that the magnetic core is difficult to fix during production and installation. The magnetic core set for forming a planar transformer includes an upper magnetic cover and a lower magnetic cover disposed on an upper surface and a lower surface of a circuit board, respectively. The upper magnetic cover and the lower magnetic cover are asymmetric structures. The upper magnetic cover directly thermally coupled to a heat dissipation device has a volume greater than that of the lower magnetic cover. Since the thermal resistance from the upper magnetic cover to the heat dissipation device is less than the thermal resistance from the lower magnetic cover to the heat dissipation device, when the volume of the lower magnetic cover is less than the volume of the upper magnetic cover, the heat generation of the lower magnetic cover relative to the upper magnetic cover will be reduced, thereby achieving uniform overall heat distribution and avoiding a series of problems caused by overheating of the lower magnetic cover. Furthermore, when the upper magnetic cover and the lower magnetic cover are connected through the through holes on the circuit board, the upper magnetic cover includes at least two magnetic columns connected to the lower magnetic cover through the through holes of the circuit board, so that the connection between the upper magnetic cover and the lower magnetic cover is located adjacent to the lower magnetic cover, and an asymmetric magnetic core combination structure is achieved. On the other hand, the lower magnetic cover is connected to the magnetic columns of the upper magnetic cover through at least one protrusion, or at least one air gap is formed between at least one protrusion of the lower magnetic cover and the magnetic columns of the upper magnetic cover. In addition to achieving uniform overall heat distribution, the at least one protrusion having the protruding height of not less than 0.9 mm is more helpful for installation and fixing the upper magnetic cover and the lower magnetic cover to the circuit board. It further solves the problem of that the magnetic core is difficult to fix during production and installation. In a magnetic core set of an upper magnetic cover and a lower magnetic cover for the planar transformer, the upper magnetic cover is directly thermally coupled to the heat dissipation device, and the connection formed by the combination of the upper magnetic cover and the lower magnetic cover can be designed adjacent to the lower magnetic cover to form an asymmetric magnetic core combination structure, thereby reducing the size of the lower magnetic cover and making the volume of the upper magnetic cover greater than the volume of the lower magnetic cover. Since the thermal resistance from the lower magnetic cover to the heat dissipation device is greater than the thermal resistance from the upper magnetic cover to the heat dissipation device, reducing the volume of the lower magnetic cover helps to reduce the heat generated from the lower magnetic cover. Thereby, a uniform overall heat distribution is achieved and a series of problems caused by overheating of the lower magnetic cover are avoided. Certainly, the air gap in the asymmetric magnetic core combination structure is not limited to be formed on a side column or a middle column.

It should be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A magnetic component, comprising:
a circuit board comprising a first surface and a second surface arranged opposite to each other, and at least two through holes passing through the first surface and the second surface; and
a magnetic core set comprising an upper magnetic cover and a lower magnetic cover respectively disposed on the first surface and the second surface of the circuit board, wherein the upper magnetic cover comprises at least two magnetic columns connected to the lower magnetic cover through the at least two through holes, respectively, wherein the upper magnetic cover is directly thermally coupled to a heat dissipation device, and a volume of the upper magnetic cover is greater than a volume of the lower magnetic cover.

2. The magnetic component according to claim 1, wherein a thermal resistance defined from the upper magnetic cover to the heat dissipation device is smaller than a thermal resistance defined from the lower magnetic cover to the heat dissipation device.

3. The magnetic component according to claim 1, wherein the at least two magnetic columns include two side columns, the upper magnetic cover is a U-shaped magnetic core, and the lower magnetic cover comprises at least one protrusion spatially corresponding to at least one of the two side columns of the upper magnetic cover and connected to the upper magnetic cover through the at least one of the at least two through holes, wherein a volume of the protrusion is smaller than a volume of the two side columns.

4. The magnetic component according to claim 1, wherein the at least two magnetic columns include two side columns, the upper magnetic cover is a U-shaped magnetic core, and the lower magnetic cover is a U-shaped magnetic core and comprises two protrusions, wherein the two protrusion of the lower magnetic cover are spatially corresponding to the two side columns of the upper magnetic cover, and connected to the upper magnetic cover through the at least two through holes, respectively, wherein a volume of the two protrusions is smaller than a volume of the two side columns.

5. The magnetic component according to claim 1, wherein the upper magnetic cover is an E-shaped magnetic core, the at least two magnetic columns include two side columns and a middle column, the lower magnetic cover is a U-shaped magnetic core and comprises two protrusions, the at least two through holes include three through holes, the two protrusions of the lower magnetic cover are spatially corresponding to the two side columns of the upper magnetic cover, and the two side columns and the middle column of the upper magnetic cover are connected to the lower magnetic cover through the three through holes, respectively, wherein a volume of the two protrusions is smaller than a volume of the two side columns.

6. The magnetic component according to claim 1, wherein the upper magnetic cover is an E-shaped magnetic core, the at least two magnetic columns include two side columns and a middle column, the lower magnetic cover is an E-shaped magnetic core and comprises three protrusions, and the at least two through holes include three through holes, wherein the three protrusions of the lower magnetic cover are spatially corresponding to the two side columns and the middle column of the upper magnetic cover, and are connected to the upper magnetic cover through the three through holes, respectively, wherein a volume of the three protrusions is smaller than a volume of the two side columns and the middle column.

7. The magnetic component according to claim 1, wherein the upper magnetic cover is an E-shaped magnetic core, the at least two magnetic columns include two side columns and a middle column, the lower magnetic cover comprises a protrusion, the at least two through holes include three through holes, the protrusion of the lower magnetic cover is spatially corresponding to the middle column of the upper magnetic cover, and the two side columns and the middle column of the upper magnetic cover are connected to the lower magnetic cover through the three through holes, respectively, wherein a volume of the protrusion is smaller than a volume of the middle column.

8. The magnetic component according to claim 1, wherein the at least two magnetic columns include two side columns and at least two middle columns, the lower magnetic cover comprises at least one protrusion, the at least two through holes include at least four through holes, the at least one protrusion of the lower magnetic cover is spatially corresponding to the at least one middle column of the upper magnetic cover, and the two side columns and the at least two middle columns of the upper magnetic cover are connected to the lower magnetic cover through the at least four through holes, respectively, wherein a volume of the at least one protrusion is smaller than a volume of the at least two middle columns.

9. The magnetic component according to claim 1, wherein the at least two magnetic columns include two side columns and at least two middle columns, the lower magnetic cover is a U-shaped magnetic core and comprises two protrusions, and the at least two through holes include at least four through holes, wherein the two protrusions of the lower magnetic cover are spatially corresponding to the two side columns of the upper magnetic cover, and are connected to the upper magnetic cover through the at least four through holes, respectively, wherein a volume of the two protrusions is smaller than a volume of the two side columns.

10. The magnetic component according to claim 1, wherein the at least two magnetic columns include two side columns and at least two middle columns, the lower magnetic cover is a U-shaped magnetic core and comprises at least four protrusions, and the at least two through holes include at least four through holes, wherein the at least four protrusions of the lower magnetic cover are spatially corresponding to the two side columns and the at least two middle columns of the upper magnetic cover, and are connected to the upper magnetic cover through the at least four through holes, respectively, wherein a volume of the at least four protrusions is smaller than a volume of the two side columns and the at least two middle columns.

11. The magnetic component according to claim 1, wherein the lower magnetic cover comprises at least one protrusion spatially corresponding to the upper magnetic cover and connected to the upper magnetic cover through the at least one of the at least two through hole, the at least one protrusion of the lower magnetic cover has a protruding height, and the protruding height is greater than or equal to 0.9 mm.

12. The magnetic component according to claim 1, wherein the at least two magnetic columns include two side columns, the upper magnetic cover is a U-shaped magnetic core, the lower magnetic cover is an I-shaped magnetic core, the at least two through holes include two through holes, and the two side columns of the upper magnetic cover are connected to the lower magnetic cover through the two through holes, respectively.

13. The magnetic component according to claim 1 wherein the at least two magnetic columns include two side columns and a middle column, and the upper magnetic cover is an E-shaped magnetic core, wherein the lower magnetic cover comprises two side columns, and the lower magnetic cover is a U-shaped magnetic core, wherein the two side columns of the lower magnetic cover are spatially corresponding to the two side columns of the upper magnetic cover, a height of the middle column of the upper magnetic cover is greater than a height of the two side columns of the upper magnetic cover, and the middle column of the upper magnetic cover forms an air gap disposed adjacent to the lower magnetic cover.

14. The magnetic component according to claim 1, wherein the at least two magnetic columns include two side columns and a middle column, the upper magnetic cover is an E-type magnetic core, the lower magnetic cover is an I-type, the at least two through holes include three through holes, and the two side columns and the middle column of the upper magnetic cover are connected to the lower magnetic cover through the three through holes, respectively.

15. The magnetic component according to claim 1, wherein the at least two magnetic columns include two side columns and at least two middle columns, the lower magnetic cover is an I-type magnetic core, the at least two through holes include at least four through holes, and the two side columns and the at least two middle columns are connected to the lower magnetic cover through the at least four through holes, respectively.

16. The magnetic component according to claim 1, wherein the at least two magnetic columns of the upper magnetic cover includes two side columns and at least one middle column, the at least two magnetic columns of the upper magnetic cover form at least one air gap disposed adjacent to the lower magnetic cover, and the at least one air gap is correspondingly formed between the at least one middle column of the upper magnetic cover and the lower magnetic cover.

17. The magnetic component according to claim 1, wherein the at least two magnetic columns of the upper magnetic cover includes two side columns, the at least two magnetic columns of the upper magnetic cover form at least one air gap disposed adjacent to the lower magnetic cover, and the at least one air gap is formed between at least one of the two side columns of the upper magnetic cover and the lower magnetic cover.

18. The magnetic component according to claim 1, wherein the magnetic component is a planar transformer, and the circuit board further comprises a winding surrounding an outer periphery of the at least two through holes.

19. The magnetic component according to claim 1, wherein the heat dissipation device is a heat sink or a thermal pad.

20. A magnetic component, comprising:
a circuit board comprising a first surface and a second surface disposed opposite to each other, and at least one through hole passing through the first surface and the second surface; and
a magnetic core set comprising an upper magnetic cover and a lower magnetic cover disposed on the first surface and the second surface of the circuit board, respectively and connected through the at least one through hole, wherein the upper magnetic cover is directly thermally coupled to a heat dissipation device, a thermal resistance defined from the upper magnetic cover to the heat dissipation device is smaller than a thermal resistance defined from the lower magnetic cover to the heat dissipation device, and a volume of the upper magnetic cover is greater than a volume of the lower magnetic cover.

21. The magnetic component according to claim 20, wherein the upper magnetic cover comprises at least one magnetic column connected to the lower magnetic cover through the at least one through hole, wherein at least one air gap is formed at a junction of the at least one magnetic column and the lower magnetic cover.

22. The magnetic component according to claim 21, wherein the lower magnetic cover comprises at least one protrusion spatially corresponding to the at least one magnetic column, and the at least one air gap is disposed at the junction of the at least one magnetic column and the at least one protrusion, wherein the at least one protrusion of the lower magnetic cover has a protrusion height, and the protrusion height is greater than or equal to 0.9 mm.

23. The magnetic component according to claim 20, wherein the upper magnetic cover comprises at least two magnetic columns, and one of the at least two magnetic columns is connected to the lower magnetic cover through an outer edge of the circuit board.
